(19) United States
(12) Patent Application Publication
(10) Pub. No.: US 2022/0033234 A1
(43) Pub. Date: Feb. 3, 2022

(54) TRUSS LIFTER

(71) Applicant: Bruce Creed, Swartz Creek, MI (US)

(72) Inventor: Bruce Creed, Swartz Creek, MI (US)

(21) Appl. No.: 16/944,343

(22) Filed: Jul. 31, 2020

(51) Int. Cl. B66C 23/20

(52) U.S. Cl. CPC B66C 23/205

(57) ABSTRACT

An article of manufacture for providing constructions aid, and more specifically, an article of manufacture for a portable, self-supporting truss-lifting winch and support is disclosed.

### TECHNICAL FIELD

This application relates in general to an article of manufacture for providing a constructions aid, and more specifically, to an article of manufacture a portable, self-supporting truss-lifting winch and support.

### BACKGROUND

Construction of many buildings requires the addition of a series of truss members between a pair of opposing walls to form the internal support structure for the roof to be built on top of the series of truss members. The opposing walls are framed and connected to each other, forming the walls of the building. At this point in time, the series of truss members needs to be lifted into the air and placed in a proper location in order to couple each truss member to the pair of opposing walls.

Truss members typically are separately constructed, brought on site and lifted into place, and coupled to the walls. Each truss member is A-shaped with a pair of rising top members connected to each other at one end to form a peak. A cross support member connects the pair of rising top members at their lower ends to form a brace that has the shape of the capital letter A. When the truss member is lifted into place, the opposing ends of the cross support member about their respective joints with the rising top members are coupled to the two opposing walls with the ends of the pair of rising top members being located on an outer side of each of the two walls.

Truss members span the entire width of the building being constructed, and thus become large and unwieldy as the truss members may space a distance of 60 feet or more. Lifting such a large and heavy object into place and orienting it into a desired configuration becomes a difficult task. Currently, motorized lifts and cranes are used to lift each truss member into place. This approach requires the use of expensive equipment and their corresponding skilled and expensive operators, along with a regular crew of construction workers who typically perform the task of coupling the truss members to the building's side walls.

Therefore, a need exists for a an article of manufacture for providing a portable, self-supporting truss-lifting winch and support that performs the task of lifting each of the truss members into place without the need for a crane and operator, thereby saving a significant expense in the construction of the building. The present invention attempts to alleviate the deficiencies of prior solutions according to the principles and example embodiments of the present invention as disclosed herein.

### SUMMARY

In accordance with the present invention, the above and other problems are solved by providing an article of manufacture for a portable, self-supporting truss-lifting winch and support according to the principles and example embodiments disclosed herein.

In one embodiment, the present invention is an article of manufacture for providing a portable, self-supporting truss-lifting winch and support.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of an article of manufacture for a portable, self-supporting truss-lifting winch and support.

FIG. 2 illustrates an example embodiment of a top support member of the article of manufacture for a portable, self-supporting truss-lifting winch and support according to the present invention.

FIG. 3 illustrates an example embodiment of a lower support and winch of the article of manufacture for a portable, self-supporting truss-lifting winch and support according to the present invention.

FIG. 4 illustrates an example embodiment of an initial truss being raised according to the present invention.

FIG. 5 illustrates an example embodiment of an article of manufacture in use lifting a truss according to the present invention.

### DETAILED DESCRIPTION

This application relates in general to an article of manufacture for providing a building construction aid, and more specifically, to an article of manufacture for a portable, self-supporting truss-lifting winch and support according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “worker,” and “user” refer to an entity, e.g. a human, using the Truss Lifter associated with the invention. The term user herein refers to one or more users.

The term “invention” or “present invention” refers to the invention being applied for via the patent application with the title “Truss Lifter.” Invention may be used interchangeably with lifter.

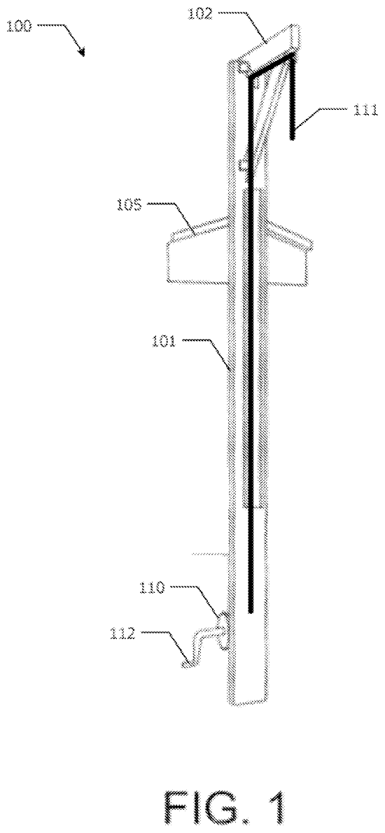

In general, the present disclosure relates to an article of manufacture for providing a building construction aid. To better understand the present invention, FIG. 1 illustrates an example embodiment of an article of manufacture for providing a portable, self-supporting truss-lifting winch and support. The Truss Lifter 100 is used by placing an upper attachment 105 over a peak of a truss member already in place on top of the walls. A lower attachment (not shown) may also be placed about the cross support member of the existing truss member at a point directly below the upper attachment 105 and the peak of the existing truss. The upper attachment 105 is coupled to a main support mast 101. An upper end of the main support mast 101 extends a distance above the upper attachment 105 to enable a horizontal support member 102 to extend outward from the existing truss member.

One end of the horizontal support member 102 is coupled to the main support mast 101 at its top end with an opposite end of the horizontal support member 102 extending outward. A lifting line 111 extends downward from the outer end of the horizontal support member 102 at one end while following a path along the lower side of the horizontal support member 102 and then downward along the main support mast 101 until it reaches a winch 110.

The Truss Lifter 100 may be used by placing the upper attachment 105 over a peak of an existing truss member. The horizontal support member 102 is oriented in the direction of a location for the next truss member in the series of truss members to be located. The task of placing the Truss Lifter 100 into place is a simple task that may be performed at most by two workers, one located on the existing truss member and a second located on the ground below the existing truss member. Once the lifter is in place the free end of the lifting line 111 may be attached to a peak of a new truss member to be lifted into place. The lifting line 111 may utilize a hook, clasp, ring and u-bolt, and similar coupling devices on the end of the lifting line 111 to secure the lifting line 111 to the new truss member.

A single worker located on the ground may then operate a winch 110 to reel in the lifting line 111 and thus raise the new truss member into place. The winch 110 may be a hand-operated winch 110 that uses a handle 112 to reel in the lifting line 111. An electric winch, or other mechanically aided winch, also may be used when the weight of the new truss member rises. The existing truss member supports the weight of the Truss Lifter 100 and the new truss member as it is lifted. Locating the Truss Lifter 100 over the peak of the existing truss member ensures that the Truss Lifter 100, and thus the new truss member, stay in place along the span of the existing truss member. When the new truss member reaches close to the horizontal support member 102, the new truss member will be located above the two opposing walls. Workers may then attach the new truss member to these walls, disconnect the lifting line 111 from the new truss member, and then move the Truss Lifter 100 to a similar location on the new truss member to repeat the process for the next truss member to be lifted into place.

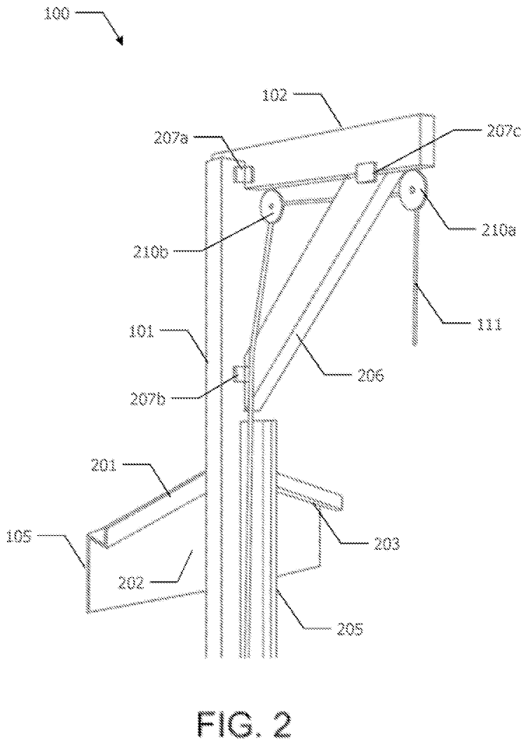

FIG. 2 illustrates an example embodiment of a top support member of an article of manufacture for a portable, self-supporting truss lifting winch and support according to the present invention. The main support mast 101 is shown from a point about the upper attachment 105 to the horizontal support member 102. A diagonal bracing member 206 is shown having its ends attached to the main support mast 101 at a lower end and to the horizontal support member 102 at its upper end. The diagonal bracing member 206 provides increased strength to the horizontal support member 102 when it is supporting the weight of a rising truss member. The diagonal bracing member 206 may be attached to the other support members 101-102 using a set of mounting hardware 207a-c.

The lifting line 111 is routed from the outer end of the horizontal support member 102 by a pair of pulleys 210a-b. The free end of the lifting line 111 drops downward from an outer pulley wheel 210a. The lifting line 111 runs from the outer pulley wheel 210a to an inner pulley wheel 210b where the line is routed downward toward the winch 110. A guide rail 205 runs the length of the main support mast 101 to attempt to keep the lifting line 111 located close to the Truss Lifter 100.

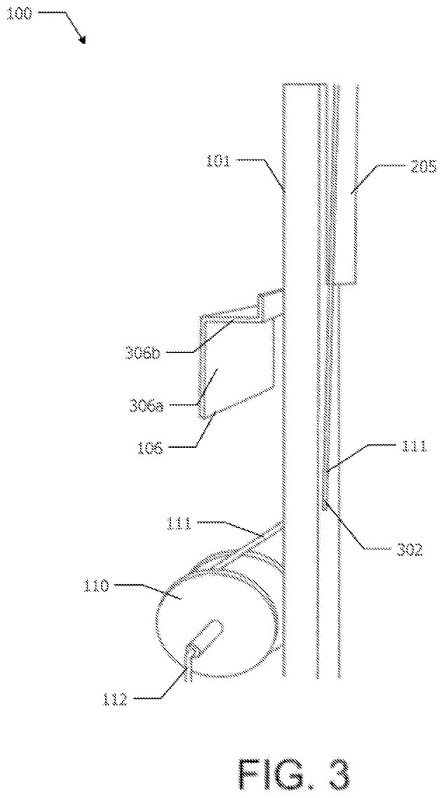

The upper attachment 105 is shown attached to the back side of the main support mast 101. The upper attachment 105 is constructed having a pair of sloping surfaces 201 that engage the peak of a truss member when in place. A flat back surface 202 is coupled to an outer edge of the pair of sloping surfaces 201 forming an attachment space large enough to slide over the sides of the pair of rising support members of an existing truss member when in place while the peak engages the pair of sloping surfaces 201. The upper attachment 105 and the lower attachment 106, as shown in detail in FIG. 3, support the weight of the Truss Lifter 100 and the new truss member when it is being lifted into place.

FIG. 3 illustrates an example embodiment of a lower support and winch of the article of manufacture for a portable, self-supporting truss lifting winch and support according to the present invention. The lifting line 111 is shown being routed down an inner side of the main support mast 101 along the guide rail 205. The lifting line 111 runs from the inner pulley wheel 210b down to a thru hole 302 in the main support mast 101 to reach the winch 110. The winch 110 and thru hole 302 may be located any distance required from the upper attachment 105 to permit a worker to operate the winch 110. As noted above, the length of the main support mast 101, the thru hole 302 and the winch 110 may be as long as necessary to position the winch 110 and its handle 112 at a height permitting a worker to operate the winch 110 while standing on the ground.

In an alternate embodiment, a lower attachment 106 is placed about the cross support member of the existing truss member at a point directly below the upper attachment 105 and the peak of the existing truss. The lower attachment 106 is coupled to an outer side of the main support member 101 having a top support surface 306b and a back support surface 306a. The top support surface 306b and the back support surface 306a are coupled together on one side of each surface that are sized to permit the cross support member of the existing truss member to slide into a space created between the lower attachment 106 and the main support member 101. The top support surface 306b engages a top surface of the cross support member of the existing truss member. The back support surface 306a engages an outer side of the cross support member of the existing truss member.

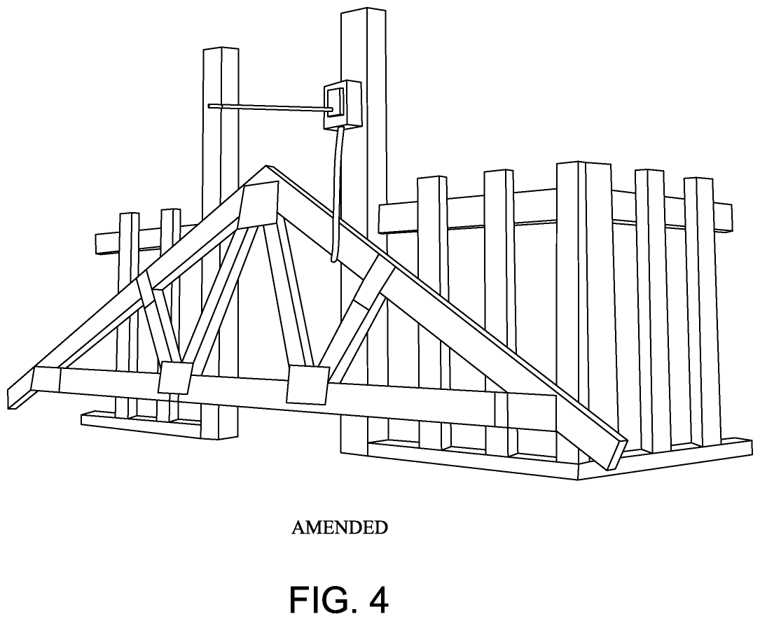

FIG. 4 illustrates an example embodiment of an initial truss being raised according to the present invention. The first truss member 401 installed onto a building cannot be raised using the Truss Lifter 100 as the Truss Lifter works when a peak 411 of a truss member 401 is in place to support the Truss Lifter 100 along with the cross support member 412. A different winch 421 may be needed to help workers raise the first truss member 401 into place so that it may be coupled to the opposing walls.

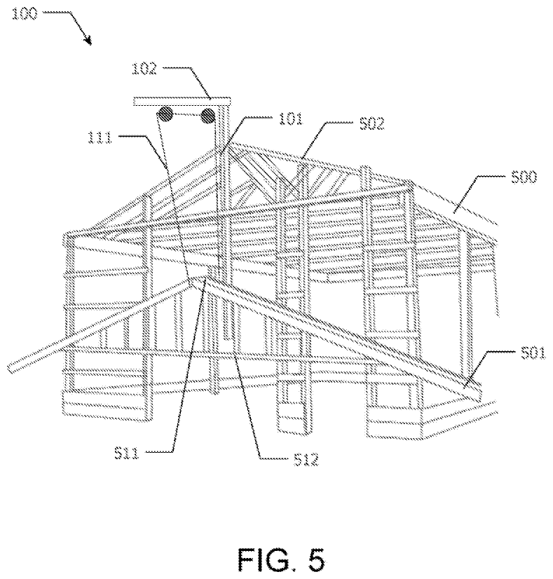

FIGS. 5 illustrates an example embodiment of an article of manufacture in use lifting a truss according to the present invention. The Truss Lifter 100 is shown attached to an existing truss member 502 that has already been coupled to the building 500. A new truss member 501 is being lifted into place with the lifting line 111 attached to the peak 511 of the new truss member 501. As a worker reels in the lifting line 111 onto the winch 110 (not shown in FIG. 5), the lifting line 111 pulls the peak 511 of the new truss member 501 into the air. When the new truss member 501 has been raised high enough for the cross support member 512 to be placed on top of the walls of the building, workers may maneuver the new truss member 501 into place and couple it to the building 500. Once the truss is in place, the Truss Lifter 100 is moved from the existing truss member 502 to the newly installed truss member 501 and the process repeats until all of the necessary truss members are installed onto the building 500.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing a portable, self-supporting truss-lifting winch and support, the article comprises:
a main support mast oriented vertically when in user, the main support mast having and upper end and a lower end;
a horizontal support member coupled to the main support mast about the upper end, the horizontal support member extends outward from the main support mast, having an inner end and an outer end;
a winch coupled about the lower end of the main support mast for lifting a truss member into place on a building under construction;
a lifting line having a free end hanging downward, the lifting line being routed from the outer end of the horizontal support member to the winch for lifting the truss member into place under control of the winch; and
an upper attachment coupled to a rear side about the upper end for attaching to a peak of an existing truss member already installed onto the building under construction.

2. The article of manufacture according to claim 1, wherein the upper attachment comprising a pair of sloping surfaces being shaped to rest on a pair of rising support members of the existing truss member when attached to the exiting truss member; and
a flat back surface coupled to an outer edge of the pair of sloping surfaces forming an attachment space large enough to slide over the sides of the pair of rising support members of an existing truss member.

3. The article of manufacture according to claim 2, wherein the article further comprises:
a thru hole in the main support mast about the winch from the front side of the main support mast to the back side of the main support mast;
an inner pulley wheel coupled to a lower side of the horizontal support member near the main support mast; and
an outer pulley wheel coupled to a lower side of the horizontal support member near the outer end of the horizontal support member;
wherein the lifting line is routed from the outer pulley wheel to the inner pulley wheel to the thru hole and around the winch.

4. The article of manufacture according to claim 1, wherein the article further comprises a bracing support member coupled between the main support mast and a middle point on the lower side of the horizontal support member.

5. The article of manufacture according to claim 1, wherein the article further comprises a guide rail coupled to the front side of the main support mast running from about the horizontal support member to the thru hole adjacent to the lifting line.

6. The article of manufacture according to claim 3, wherein the article further comprises a coupling device attached to the free end of the lifting line for securing the lifting line to the truss support member being lifted into place.

7. The article of manufacture according to claim 6, wherein the coupling device comprises a hook, clasp, ring and u-bolt.

8. The article of manufacture according to claim 1, wherein the article further comprises a lower attachment coupled to the main support mast above the thru hole and winch for securing the main support mast to a cross support member of the existing truss member.

9. The article of manufacture according to claim 1, wherein the winch is a hand-operated winch.

10. The article of manufacture according to claim 1, wherein the winch is a motorized winch.

11. An article of manufacture for providing a portable, self-supporting truss-lifting winch and support, the article comprises:
a main support mast oriented vertically when in user, the main support mast having and upper end and a lower end;
a horizontal support member coupled to the main support mast about the upper end, the horizontal support member extends outward from the main support mast, having an inner end and an outer end;
a winch coupled about the lower end of the main support mast for lifting a truss member into place on a building under construction;
a lifting line having a free end hanging downward, the lifting line being routed from the outer end of the horizontal support member to the winch for lifting the truss member into place under control of the winch;
a coupling device attached to the free end of the lifting line for securing the lifting line to the truss support member being lifted into place.
a thru hole in the main support mast about the winch from the front side of the main support mast to the back side of the main support mast;
a guide rail coupled to the front side of the main support mast running from about the horizontal support member to the thru hole adjacent to the lifting line;
a bracing support member coupled between the main support mast and a middle point on the lower side of the horizontal support member;
an upper attachment coupled to a rear side about the upper end for attaching to a peak of an existing truss member already installed onto the building under construction, the upper attachment comprising:
a pair of sloping surfaces being shaped to rest on a pair of rising support members of the existing truss member when attached to the exiting truss member; and
a flat back surface coupled to an outer edge of the pair of sloping surfaces forming an attachment space large enough to slide over the sides of the pair of rising support members of an existing truss member;
an inner pulley wheel coupled to a lower side of the horizontal support member near the main support mast; and
an outer pulley wheel coupled to a lower side of the horizontal support member near the outer end of the horizontal support member;
wherein the lifting line is routed from the outer pulley wheel to the inner pulley wheel to the thru hole and around the winch.

12. The article of manufacture according to claim 11, wherein the coupling device comprises a hook, clasp, ring and u-bolt.

13. The article of manufacture according to claim 1, wherein the article further comprises a lower attachment coupled to the main support mast above the thru hole and winch for securing the main support mast to a cross support member of the existing truss member.

14. The article of manufacture according to claim 11, wherein the winch is a hand-operated winch.

15. The article of manufacture according to claim 11, wherein the winch is a motorized winch.
